(19) United States
(12) Patent Application Publication
(10) Pub. No.: US 2019/0224762 A1
(43) Pub. Date: Jul. 25, 2019

(54) Cooling Channel Opening By Means Of Circular Milling Operation

(71) Applicant: KS Kolbenschmidt GmbH, Neckarsulm (DE)

(72) Inventors: Wolfgang Köhler, Massenbachhausen (DE); Dieter Krämer, Heilbronn (DE); Florian Leppla, Seckach-Großeicholzheim (DE)

(21) Appl. No.: 16/309,369

(22) PCT Filed: Jun. 13, 2017
(86) PCT No.: PCT/EP2017/064433

§ 371 Date: Dec. 12, 2018

(30) Foreign Application Priority Data
Jun. 13, 2016 (DE) 10 2016 210 395.4

(51) Int. Cl. B23C 3/02; B23C 5/10; F02F 3/22; B23P 15/10

(52) U.S. Cl. CPC B23C 3/02; B23C 5/10; F02F 3/22; B23C 2220/52; B23C 2210/088; B23C 2215/24; B23P 15/10

(57) ABSTRACT

The invention relates to a method for producing a cooling channel piston, wherein a blank of the cooling channel piston, which has a cavity designed as a cooling channel, is provided and wherein an inlet or outlet opening is introduced into the blank in the direction of the cooling channel, characterized in that the opening is introduced into the blank by means of a CNC-controlled circular milling process by using a special milling cutter having end cutting edges arranged in a shaft profile.

### TECHNICAL FIELD

The invention relates in general to a tool with which a through opening is intended to be made through solid material in the direction of a cavity in the solid material. Particularly preferably, an inlet or outlet opening is made in a piston which has as the cavity a cooling channel.

### BACKGROUND

In known milling or drilling operations, with which a through opening is made in a solid material in the direction of a cavity, chips are disadvantageously formed, which chips can also penetrate into the cavity and remain there. In cooling channel pistons in particular, such chips or, in general, residues of the drilling or milling operation are disadvantageous, since these can make their way into the oil circuit of the internal combustion engine and can lead there to problems.

In order to remedy these drawbacks, it has already been envisioned to use an electrochemical drilling method (ECM method). With this method, a situation in which particles are able to make their way into the cavity (in pistons, into the cooling channel) is certainly more or less effectively avoided. However, this involves a chemical method, which on the one hand is disadvantageous since it pollutes the environment and, on the other hand, likewise has the drawback that the desired cycle times in the series production of pistons are hence unobtainable.

### BRIEF DESCRIPTION OF THE DRAWINGS

FIG. 1 shows by way of example the face cutting edges, arranged in a wave profile, of a special milling cutter tool.

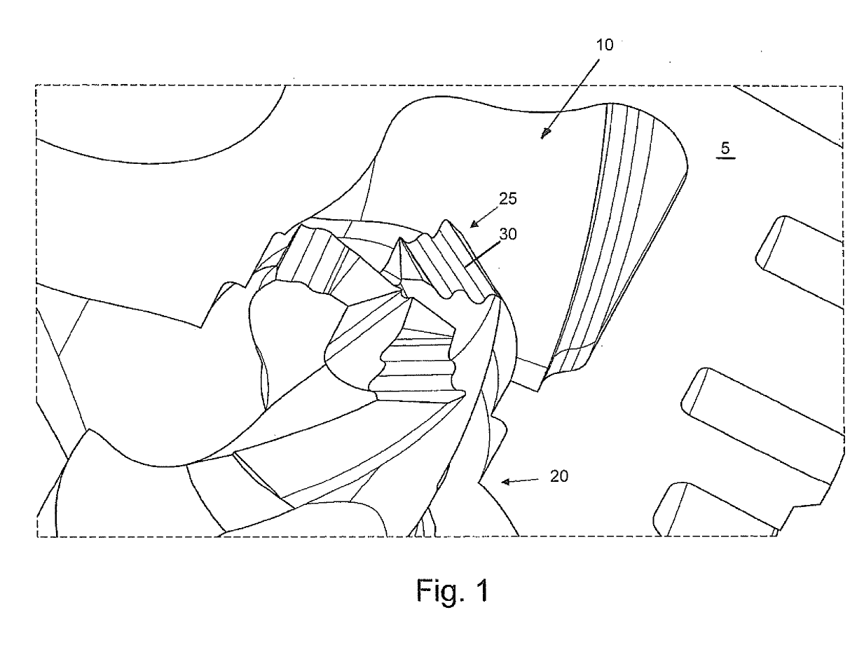

FIG. 2 is a cross-sectional view showing the tool according to FIG. 1 during the machining of an inlet or outlet opening in the direction of a cooling channel of a piston of an internal combustion engine.

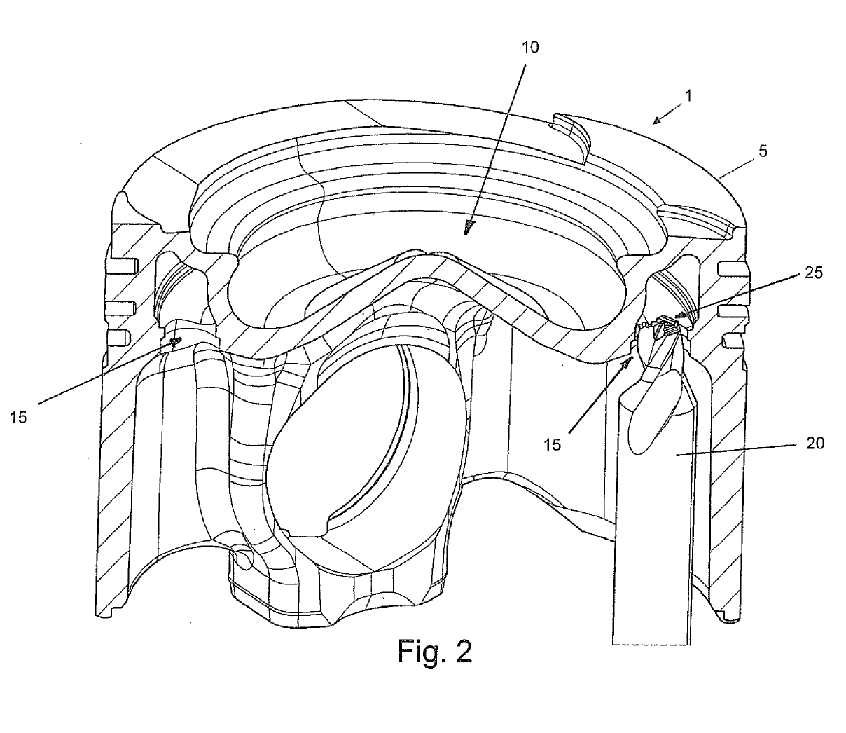

### DETAILED DESCRIPTION

In particular, the invention relates to a method for producing a cooling channel piston 1, wherein a blank 5 of the cooling channel piston, which has a cavity 10 configured as a cooling channel, is provided, and in which an inlet or outlet opening 15 is made in the blank in the direction of the cooling channel, and to a cooling channel piston produced according to the method.

The object of the invention is therefore to avoid the drawbacks depicted in the background and to provide an improved method for making through openings in solid material in the direction of a cavity, in particular in the production of cooling channel pistons.

With respect to the method, it is provided that firstly, in any chosen known manner, a blank 5 of a cooling channel piston 1 is provided (for example a single-part or multipart cast or forged blank, though this list is not exhaustive) and, according to the invention, the opening 15 is made in the blank 5 by a CNC-controlled circular milling process, using a special milling cutter or tool 20 having face cutting edges 25 arranged in a wave profile.

The object is thus achieved by a special shape of a milling tool 20, with which a situation in which particles, in particular chips, are able to make their way into the cavity 10 is avoided. This milling cutter 20 has face cutting edges 25 arranged in a wave profile, so that, by means of the CNC-controlled circular milling process, the through opening 15 can be made in the solid material. The special arrangement of the cutters of the milling tool has the advantage that only very small particles can be formed, which particles are led away from the cavity by means of suitable shaping (spiral channel shape, pointing away from the face cutting edges) of the milling cutter. Should such particles, however, penetrate into the cavity 10, these can be fully flushed out of the cavity with a following flushing process, since they have a dimension which is substantially (very markedly) smaller than the cross section of the through bore in which is made in the solid material (of the blank). Moreover, by means of the face cutting edges 25 arranged in the wave profile, a situation in the prior art is avoided in which, when the milling tool passes out of the solid material in the direction of the cavity, a type of cap is formed (as in the prior art), which cap either gets stuck on the solid material and, in the case of a cooling channel piston, for example, impedes the flow of oil into the cooling channel or even becomes detached and discretely remains in the cavity, which leads to the same drawbacks.

In a preferred embodiment, the special milling cutter 20 (also termed “circular milling cutter”) possesses a point angle ranging from 170 degrees to 180 degrees, in particular of 174 degrees, in order to avoid “capping” as the circular milling cutter 20 passes out of the solid material (into the cooling channel). Furthermore, the circular milling cutter has at least two, in particular, however, more than two rows of teeth 30 (preferably precisely three), which are of wavy in form. The waves of each individual tooth row preferably overlap those of the following tooth row.

By virtue of the CNC-control of the circular milling process, any chosen cross sections and longitudinal geometries of the through opening 15 can be made. In terms of the longitudinal geometries, a trumpet-shaped, a funnel-shaped or other geometry, for instance, is conceivable. In cooling channel pistons, outwardly widened longitudinal geometries of the through opening are advantageous, since in such a case they act as a collecting funnel for the oil jet which is to be injected. In terms of the cross section of the through opening, round, elongate and other chosen geometries, which are realizable by means of the circular milling process, can enter into consideration. Circular milling is a face/peripheral milling with circular feed motion of the tool about its longitudinal axis (spiral intrusion into the material).

With respect to the cooling channel piston, a cooling channel piston 1 which has a cooling channel 10 and at least one inlet and/or at least one outlet opening 15 in the direction of a cooling channel and in which an inlet or outlet opening 15 is made in the direction of the cooling channel by a CNC-controlled circular milling process, using a special milling cutter 20 having face cutting edges 25 arranged in a wave profile and having a subsequent high pressure flushing operation, is provided. In this respect, the same advantages apply as already set out above with regard to the method.

Not shown, but necessary, is a flushing-out process, after the through opening 15 has been realized by means of the special milling cutter 20, in order to remove particles from the cavity 10 if such have penetrated there. Since the special milling cutter 20, however, with its face cutting edges 25 arranged in the wave profile, generates only very small particles during the circular milling process, these can readily, by virtue of the high-pressure flushing operation, be effectively and fully removed from the cavity, in particular the cooling channel of the piston. As a result, the cycle time in the series production of pistons, in particular in relation to the ECM method, is able to be markedly reduced. Moreover, a further advantage is given by the fact that the machine and the operation of the special tool is markedly cheaper, in terms of both purchase and maintenance, than machinery and equipment required for the ECM method.

1. A method for producing a cooling channel piston, wherein a blank of the cooling channel piston, which defines a cavity operable as a cooling channel, is provided, and in which one of an inlet or outlet opening is made in the blank in a direction of the cooling channel, characterized in that the one of the inlet or outlet opening is made in the blank by a CNC-controlled circular milling process, using a special milling cutter having face cutting edges arranged in a wave profile.

2. The method of claim 1, characterized in that particles formed in an execution of the circular milling process are directed away from the cavity by means of a spiral channel shape, pointing away from the face cutting edges of the milling cutter.

3. The method of claim 1, characterized in that, after the opening has been made, the cooling channel is subjected to a high-pressure flushing operation.

4. The method of claim 1, characterized in that the special milling cutter comprises a point angle ranging from 170 degrees to 180 degrees.

5. A cooling channel piston which has a cooling channel and at least one of an inlet or an outlet opening in a direction of the cooling channel, and in which one of an inlet or an outlet opening is made in the direction of the cooling channel by a CNC-controlled circular milling process, using a special milling cutter having face cutting edges arranged in a wave profile and having a subsequent high-pressure flushing operation.

6. The method of claim 2, characterized in that, after the opening has been made, the cooling channel is subjected to a high-pressure flushing operation.

7. The method of claim 4, characterized in that the special milling cutter comprises a point angle of 174 degrees.

8. A method for producing a cooling channel opening in an internal combustion engine piston, the method comprising:
providing a piston blank having a wall defining a cooling channel;
positioning a CNC-controlled device having a milling cutter proximate the cooling wall channel, the milling cutter including at least two cutting teeth each having face cutting edges;
rotatably engaging the milling cutter face cutting edges with the cooling channel wall in a direction of the cooling channel forming removed cooling channel wall particles, the face cutting edges positioned on at least two teeth;
directing the removed cooling channel wall particles away from the cooling channel through a spiral channel shape extending away from the face cutting edges in the milling cutter; and
forming a cooling channel inlet opening through the cooling channel wall in communication with the cooling channel.

9. The method of claim 8 further comprising the step of:
high-pressure flushing the cooling channel to remove any of the removed cooling channel wall particles positioned in the cooling channel following forming of the cooling channel inlet.

10. The method of claim 8 wherein the face cutting edges are wavy in form, the step of engaging the milling cutter face cutting edges further comprises:
engaging the wavy form teeth of the face cutting edges forming the removed cooling channel wall particles.
